(19) United States
(12) Patent Application Publication
(10) Pub. No.: US 2024/0281638 A1
(43) Pub. Date: Aug. 22, 2024

(54) DATA SERVICE METHOD AND DEVICE, AND RELATED PRODUCT

(71) Applicant: Beijing Bytedance Network Technology Co., Ltd., Beijing (CN)

(72) Inventors: Maojia SHENG, Beijing (CN); Zhongnan HUANG, Beijing (CN); Zilin XU, Beijing (CN); Jingting JIN, Beijing (CN)

(21) Appl. No.: 18/571,131

(22) PCT Filed: Sep. 21, 2022
(86) PCT No.: PCT/CN2022/120165

§ 371 Date: Dec. 15, 2023

(30) Foreign Application Priority Data
Oct. 8, 2021 (CN) 202111173249.9

(51) Int. Cl. G06N 3/04

(52) U.S. Cl. CPC G06N 3/04

(57) ABSTRACT

The present application discloses a data service method and device, and related products. After a process of a target data service is started, a candidate dataset outside a neural network graph structure and corresponding to a target data service is obtained through a custom operator in the neural network graph structure; the neural network graph structure and the candidate dataset obtained by the custom operator in the previous step are then used to execute the target data service. A hybrid graph computing framework that combines a usage mode inside the graph with a usage mode outside the graph is realized with the aid of the custom operator. The custom operator is located inside the graph, and the candidate data is located outside the graph. The custom operator can access the candidate data outside the graph, so that the candidate data can participate in the target data service.

The present application claims the priority of Chinese patent application No. 202111173249.9 filed with the CNIPA on Oct. 8, 2021, entitled “DATA SERVICE METHOD, DEVICE AND RELATED PRODUCT”, which is incorporated herein by reference in its entirety.

### TECHNICAL FIELD

The present disclosure relates to the technical field of machine learning, in particular to a data service method, device and related product.

### BACKGROUND

Machine learning is an interdisciplinary subject, which studies how computers can simulate or realize human learning behaviors to acquire new knowledge or skills and reorganize the existing knowledge structure to continuously improve their own performances. Machine learning technology represented by deep learning is widely applied in big data scenarios such as recommendation, advertisement and search. Under such big data scenarios, online systems are required to calculate huge amount of data (such as contents, advertisements, the number of users or the like of large-scale Internet services) online and get recommendation ranking results. Deep neural network has typical characteristics of complex structure and deep level, with graphic computing framework as its major computing framework, so as to be adapted to the complex neural network structure. Typical computing frameworks for deep neural network include TensorFlow, PyTorch and the like, which are characterized by supporting complete training and linear reasoning calculation for deep neural network. TensorFlow is an open source deep learning framework created by Google developers. PyTorch is one of the latest deep learning frameworks, and is developed by Facebook team.

In an online computing scenario for big data, it is generally necessary to use large-scale candidate data as a dataset participating in calculation for online computing. For example, in a recommendation scenario, when performing a pre-ranking calculation, thousands pieces of data need to be extracted from hundreds of millions pieces of candidate data to participate in the prediction and reasoning calculation of neural network. The dataset of the candidate data is usually in the form of a very large-scaled N×M matrix, wherein N represents the number of pieces of the data and M represents the dimension of the data.

At present, according to the combination mode of the candidate data and the neural network graph structure of the deep learning graph computing framework, the candidate data can be used in two ways, namely, a usage mode inside the graph and a usage mode outside the graph. Among them, the usage mode inside the graph means that large-scale candidate data is solidified into the neural network graph structure of graph computing frameworks such as TensorFlow and Pytorch in advance in the form of tensor matrix input, and the neural network graph structure and the candidate data matrix are serialized in the same way by using a serialization method for graph computing framework and then distributed to online services for reasoning calculation or the like. The usage mode outside the graph means that the candidate data matrix is used as an external input parameter of the neural network graph structure and is input to the neural network graph structure during reasoning calculation.

For the above-described usage mode inside the graph, due to the constraints of the deep learning graph computing framework on a data scale, a memory allocation mode of data, a serializing mode of data and a copy number of data in the memory, the candidate data and the deep learning framework are in a “binding” relationship, resulting in that the candidate data and the neural network graph structure cannot be updated and adjusted independently, and the freedom of storing the candidate data is also limited, which is very inconvenient.

For the above-mentioned usage mode outside the graph, it is necessary to prepare candidate data outside the deep learning graph computing framework and process the candidate data into input parameters of the graph structure. In such implementation, it is very difficult to transfer and maintain the parameters in the graph structure, and also causes extra computational overhead required for the transfer of parameters.

In order to provide data services (such as reasoning calculation) in scenarios such as recommendation, advertisement, search and the like, it is usually necessary to cache the candidate data locally on a device and update the candidate data regularly. How to improve the freedom of storing and updating the candidate data, avoid unnecessary computational resource overhead, and reduce the difficulty in implementing parameter transfer and parameter maintenance in graph structure have become urgent problems to be solved in providing data services under big data scenarios such as recommendation, advertisement, search and the like.

### SUMMARY

In view of the above-mentioned problems, embodiments of the present disclosure provide a data service method, device and related product to improve the freedom of storage and update of the candidate data, avoid unnecessary computational resource overhead, and reduce the difficulty of implementing parameter transfer and parameter maintenance in the graph structure.

The embodiments of the present disclosure disclose the following technical solutions.

A first aspect of the embodiments of the present disclosure provides a data service method, including:
acquiring a candidate dataset that is outside a neural network graph structure and corresponding to a target data service through a custom operator in the neural network graph structure after a process of the target data service being started; and
executing the target data service by using the neural network graph structure and the candidate dataset.

A second aspect of the embodiments of the present disclosure provides a data service device, including:
a candidate dataset acquisition module, configured to acquire a candidate dataset that is outside a neural network graph structure and corresponding to a target data service through a custom operator in the neural network graph structure after a process of the target data service being started; and
a data service module, configured to execute the target data service by using the neural network graph structure and the candidate dataset.

A third aspect of the embodiments of the present disclosure provides a processor for performing the data service method provided by the first aspect upon executing a program.

A fourth aspect of the embodiments of the present disclosure provides an electronic apparatus for data service, including:
one or more processors; and a memory configured for storing one or more programs;
the one or more programs, upon being executed by the one or more processors, are configured to cause the one or more processers to realize the data service method provided by the first aspect.

A fifth aspect of the embodiments of the present disclosure provides a computer-readable storage medium having a computer program stored thereon, wherein the computer program is configured to realize the data service method provided by the first aspect upon being executed by a processer.

Compared with the prior art, the embodiments of the present disclosure achieve the following beneficial effects.

The data service method in the embodiment of the present disclosure includes acquiring a candidate dataset that is outside a neural network graph structure and corresponding to a target data service through a custom operator in the neural network graph structure after a process of the target data service being started, and then executing the target data service by using the neural network graph structure and the candidate dataset acquired through the custom operator in the previous step. In the embodiments of the present disclosure, a hybrid graph computing framework that combines a usage mode inside the graph with a usage mode outside the graph is realized with the aid of the custom operator. Among them, the custom operator is located inside the graph (that is, inside the graph structure), and the candidate data is located outside the graph (that is, outside the graph structure). The custom operator inside the graph can access and acquire the candidate data outside the graph, so that the candidate data can participate in the target data service. In this solution, the candidate data is not solidified in the graph structure, and hence is capable of decoupling from the graph structure. Therefore, the degree of freedom of updating and storing the candidate data is improved. In addition, the candidate data is accessed and read through the custom operator, and is not used as an input parameter of the entire graph structure, so the influence of the candidate data on the parameters in the graph structure is avoided. In this way, unnecessary computational resource overhead is avoided and the difficulty in implementing parameter transfer and parameter maintenance in the graph structure is reduced.

### BRIEF DESCRIPTION OF THE DRAWINGS

In order to more clearly illustrate the technical solutions of the embodiments of the present disclosure or the prior art, the drawings necessary for the description of the embodiments or the prior art will be briefly described in the following. It is apparent that the described drawings are only part of the embodiments of the present disclosure. For those ordinarily skilled in the art, other drawings may be obtained based on these drawings without paying creative labor.

FIG. 1 is a schematic diagram of acquiring candidate data outside a graph structure through a custom operator inside the graph structure provided by an embodiment of the present disclosure;

FIG. 2 is a flowchart of a data service method provided by an embodiment of the present disclosure;

FIG. 3 is a flowchart of another data service method provided by an embodiment of the present disclosure;

FIG. 4 is a schematic structural diagram of a data service device provided by an embodiment of the present disclosure;

FIG. 5 is a schematic structural diagram of another data service device provided by an embodiment of the present disclosure;

FIG. 6 is a schematic structural diagram of yet another data service device provided by an embodiment of the present disclosure; and

FIG. 7 is a schematic structural diagram of an electronic apparatus provided by an embodiment of the present disclosure.

### DETAILED DESCRIPTION

As described above, currently, it needs to use candidate data in many big data scenarios. The usage mode of these candidate data includes a usage mode inside the graph and a usage mode outside the graph. These two usage modes have their own shortcomings. For the usage mode inside the graph, the candidate data needs to be solidified into the neural network graph structure and closely coupled with the graph structure, which makes the update and storage of the data are limited in a deep learning graph computing framework to which the graph structure belongs, resulting in extremely poor degree of freedom. For the usage mode outside the graph, the candidate data needs to be preprocessed into parameters suitable for input into the graph structure. In this mode, the introduction of the candidate data as input parameters increases the difficulty of parameter transfer and parameter maintenance in the graph structure, and also brings in additional computational overhead. As it can be seen, both of data update and parameter transfer in the graph structure will be inconvenient due to the usage mode of the current candidate data. Candidate data is the data basis for providing data services, and the inconvenience caused by the usage mode of the candidate data will also lower the upper limit of capacity of data services. For example, in big data scenarios such as recommendation and search, it may result in problems such as inaccurate recommendation results and search results, unstable accuracy and poor matching degree, etc.

In view of the above-mentioned problems, embodiments of the present disclosure provide a method and a device for realizing data services through a hybrid graph computing architecture by combining the usage mode inside the graph with the usage mode outside the graph. Hereinafter, detailed description will be given in conjunction with embodiments and drawings.

In an embodiment of the present disclosure, a custom operator inside the graph structure is adopted to acquire candidate data outside the graph structure. In some application scenarios (such as a recall calculation), only a candidate dataset is required to be obtained for carrying out the subsequent calculation, and it is unnecessary to acquire a certain piece of candidate data. While in all other application scenarios, it may be necessary to be specified to acquire a certain piece of candidate data. In the following embodiments, the implementation method of acquiring a candidate dataset for data service is firstly introduced.

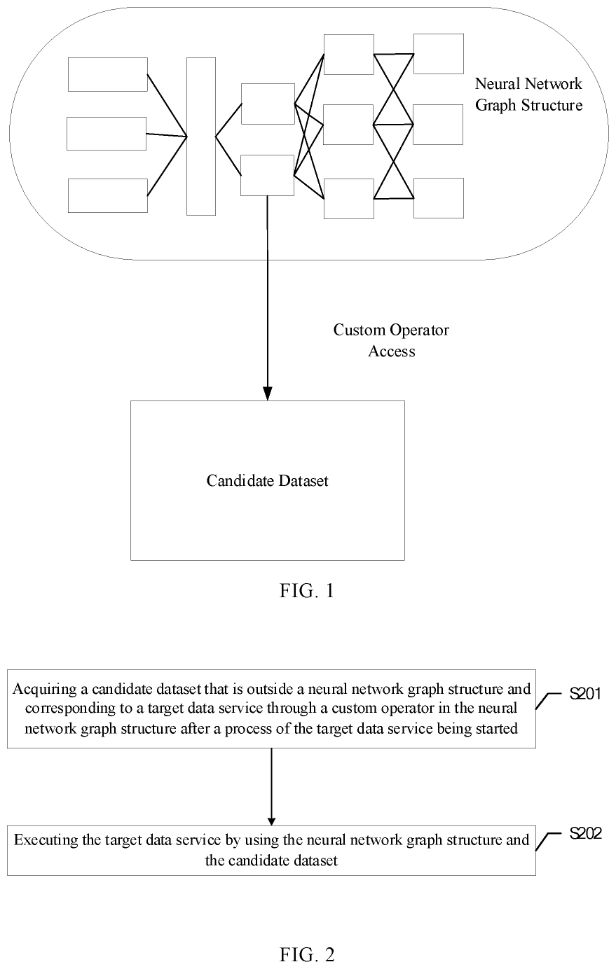

Referring to FIG. 1, which is a schematic diagram of acquiring a candidate dataset outside a graph structure through a custom operator inside the graph structure, as provided by an embodiment of the present disclosure. The neural network graph structure shown in FIG. 1 can be implemented on the basis of a neural network graph structure in an open source deep learning graph computing framework such as TensorFlow or Pytorch. The neural network graph structure shown in FIG. 1 differs from the commonly used neural network graph structure at present in that it includes a custom operator (Custom Op) inside the graph structure, and the custom operator is a part of the graph structure. The custom operator can be configured to acquire data outside the graph structure, for example, large-scale candidate data that is often required to meet the demands of data services in big data scenarios. The custom operator can be introduced onto any node in the neural network graph structure, and a candidate dataset outside the graph can be accessed through the custom operator at a certain node, as shown in FIG. 1.

Referring to FIG. 2, which is a flowchart of a data service method provided by an embodiment of the present disclosure. The data service method shown in FIG. 2 includes:

S201: acquiring a candidate dataset that is outside a neural network graph structure and corresponding to a target data service through a custom operator in the neural network graph structure after a process of the target data service being started.

The data service mentioned in the embodiment of the present disclosure refers to a calculation process which is carried out online and requires for a large number of candidate data as the data basis. In the embodiment of the present disclosure, a target data service is defined for convenience of explanation. The target data service specifically refers to a data service that has a specific purpose and needs to be executed urgently. As an example, the target data service may be providing search results based on search terms, or recommending goods based on the user's historical shopping information.

Based on different target data services, there are also differences in the data basis required for calculation. For example, when the target data service is to provide search results based on search terms, the candidate data corresponding to the target data service may be news reports; when the target data service is to recommend goods based on the user's historical shopping information, the candidate data corresponding to the target data service may be commodity information.

Before executing the target data service, a process of the target data service needs to be firstly started. The start of the process of the target data service may be triggered by a specific operation. For example, the start of the process of the target data service is triggered in response to a confirmation operation after a user inputs a search word. For another example, the start of the process of the target data service is triggered in response to the user's swiping operation on a commodity page. In practical application, the triggering mechanism for starting the data service process is not limited to the above-described triggering mechanisms for starting the process, and there is no restriction on the triggering mechanism for starting the data service process here.

With reference to FIG. 1, after the process of the target data service is started, a candidate dataset that is outside the neural network graph structure and corresponding to the target data service can be acquired through a custom operator in the neural network graph structure. In an optional implementation, the candidate data is encapsulated in a data structure outside the neural network graph structure in advance. As an example, the data structure may be a matrix, for example, one row or one column of the matrix may represent one piece of candidate data, and another dimension in the matrix represents a constituent dimension of one piece of candidate data. One piece of candidate data in the matrix may be expressed in the form of a vector. This data structure contains large number of candidate data, and hence can be used as a candidate dataset.

In practical application, each candidate dataset has a name, and each piece of candidate data in the candidate dataset has a unique identification. For example, the sequence number of the row or column, where the candidate data is located in the candidate dataset, may be used as the identification of the candidate data. Of course, the candidate data may also be assigned with an identification according to the content or usage of the candidate data. There is no restriction on the form of expression of the identification here. The name of the candidate dataset may be a unique code assigned by random or by other means, and may also be a description generated based on a content or function of the candidate dataset. Different candidate datasets have different names, so the name of the candidate dataset can be used to uniquely determine the candidate dataset. In addition, a candidate dataset has a uniquely corresponding pointer address in the data structure where the candidate dataset is encapsulated, and the pointer address can be used to obtain the candidate dataset in subsequent steps. During practical implementation, in order to ensure that the custom operator can be utilized to realize obtaining a candidate dataset outside the graph structure, a preset information carrier can be set such that the name of the candidate dataset is used as a name of the carrier, and the pointer address of the candidate dataset is added to a content of the carrier. Moreover, the name of the candidate dataset is set as a solidified parameter of the custom operator.

In this way, when the step S201 is performed, specifically, the pointer address of the candidate dataset corresponding to the target data service can be obtained by the custom operator according to the solidified parameter and the preset information carrier described above. The preset information carrier is obtained through the custom operator according to the solidified parameter (in this case, the name of the candidate dataset in the solidified parameter is used as an index). Then, according to the preset information carrier, the content thereof is queried to obtain the pointer address of the candidate dataset. Finally, the custom operator accesses and acquires the candidate dataset outside the graph according to the pointer address.

The preset information carrier described in the embodiment of the present disclosure refers to an information carrier that makes it possible to acquire the candidate dataset outside the graph through its own name and content. In practical application, the preset information carrier includes a variety of implementations. For example, the preset information carrier may be a static variable, a shared variable in a shared memory, or files. By way of example, in the case where the preset information carrier is a shared variable, the name of the candidate dataset is taken as the name of the shared variable, and the pointer address of the candidate dataset is taken as the value of the shared variable. the implementation of the preset information carrier is not limited in the embodiments of the disclosure.

The implementation of the above-described solution realizes the direct acquisition of the candidate dataset based on the pointer address of the candidate dataset. As another implementation, the candidate dataset may be encapsulated in advance to obtain an encapsulation class of the candidate dataset, and then an interface function of the encapsulation class is invoked by the custom operator to acquire the candidate dataset. It should be noted that in practical application, before providing the target data service, some preset calculations may be performed based on the candidate dataset to obtain corresponding calculation results. The calculation method of the preset calculation may be predetermined, for example, the preset calculation may be finding an average value, getting a minimum value or a sorting result, etc. The calculation method of the preset calculation may be related to the target data service, and the preset calculation is not limited in the embodiments of the present disclosure. The calculation result of the preset calculation may also be obtained by invoking the interface function of the encapsulation class. In specific implementation, it's possible to choose to acquire the candidate dataset or acquire the calculation result obtained by performing the preset calculation based on the candidate dataset, depending on the usage requirements of the target data service.

The above-described implementation realizes the indirect acquisition of the candidate dataset or the related calculation result by invoking an interface function of the encapsulation class. Since the candidate dataset is located outside the neural network graph structure, the candidate dataset and the neural network graph structure are separated from each other. Serving as a bridge between the graph structure and the candidate dataset outside the graph, the custom operator inside the graph structure enables the candidate dataset to participate in the target data service executed by the graph structure.

S202: executing the target data service by using the neural network graph structure and the candidate dataset.

After S201 is carried out, the neural network graph structure has acquired the candidate dataset outside the graph with the aid of the custom operator. Then, the neural network graph structure can execute the target data service according to the acquired candidate dataset. It should be noted that, graph parameters in the neural network graph structure mentioned in the embodiments of the present disclosure have been well trained in advance. Therefore, this step S202 describes the process that the neural network graph structure performs a graph calculation based on the candidate dataset to obtain an execution result (such as search result, recommendation result) of the target data service.

In different application scenarios, the target data services involved may be different. In addition, the neural network graph structure may be different in structure and parameters depending on actual needs. The structure and parameters of the neural network graph structure, as well as the implementation process of executing the target data service are not limited here.

The above is a data service method provided by the embodiment of the present disclosure. In this method, a hybrid graph computing framework that combines the usage mode inside the graph with the usage mode outside the graph is realized with the aid of a custom operator. Among them, the custom operator is located inside the graph (that is, inside the graph structure), and the candidate dataset is located outside the graph (that is, outside the graph structure). The custom operator inside the graph can access and acquire the candidate dataset outside the graph, so that the data in the candidate dataset is able to participate in the target data service. In this solution, the candidate dataset is not solidified into the graph structure, and therefore decoupling the candidate dataset from the graph structure is realized. As such, the degree of freedom of updating and storing the candidate dataset is improved. In addition, the candidate dataset is accessed and read by a custom operator and is not used as an input parameter of the entire graph structure, therefore, the influence of the candidate data on the parameters in the graph structure is avoided. In this way, unnecessary computational resource overhead is avoided and the difficulty in implementing parameter transfer and parameter maintenance in the graph structure is reduced.

In some scenarios, it may be necessary to use one or more pieces of candidate data in the candidate dataset to execute the data service. For convenience of explanation, such kind of candidate data is referred to as target candidate data herein.

In order to acquire the target candidate data, an identification of the target candidate data may be acquired firstly. In the implementation of S202, specifically, the target candidate data may be extracted from the candidate dataset according to the identification of the target candidate data, and then the target data service is executed by using the neural network graph structure and the target candidate data. In the scenario of encapsulating the candidate dataset into an encapsulation class, it is also possible to perform a preset calculation on the target candidate data from the encapsulation class according to the identification of the target candidate data and obtain a calculation result, and finally execute the target data service by using the neural network graph structure and the calculation result.

As compared with the usage mode inside the graph and the usage mode outside the graph of the candidate dataset, the candidate dataset in the technical solution provided by the embodiments of the present disclosure is decoupled from the graph structure. As a result, when the candidate dataset needs to be updated (when the whole dataset or part of the candidate data needs to be updated), the candidate data can be independently updated without affecting the graph structure; and at the same time, the deep learning graph computing framework to which the graph structure belongs will not cause constraints or restrictions on the update of the candidate dataset. The embodiments of the present disclosure realize a more flexible and faster data updating mechanism. In addition, the graph structure can also be independent of the candidate dataset, and thus be updated separately. Similarly, the update of the graph structure will not affect the existing candidate dataset, either. Therefore, faster update of parameters of the graph structure is achieved, without being limited by the updating speed of large-scale data.

In some possible implementation scenarios, the target data service is implemented by a plurality of neural network computing devices. The neural network computing device mentioned here may be a graphics card, or other dedicated chips. The description will be given with reference to the case of graphics card by way of example. Specifically, the neural network graph structure has a plurality of copies, and the plurality of copies are loaded into a plurality of graphics cards in one-to-one correspondence after the target data service is started. Since the candidate data is usually large-scale data (in the form of a candidate dataset) while the graphics card has relatively small video memory, storing the candidate dataset in each of the graphics card will affect the performance of the graphics card. In the embodiment of the present disclosure, the neural network graph structure is decoupled from the candidate dataset, so that the candidate dataset can be stored outside the plurality of graphics cards, for example, one copy of candidate data may be stored in an internal memory. The replication of the graph structure will not cause the replication of the candidate data. For a plurality of graphics cards, the candidate dataset outside the graph is commonly shared and does not need to be stored in the video memory of each graphics card. In this way, the memory resources are saved and the performance of the graphics card is improved.

In this scenario, executing the target data service by using the neural network graph structure and the candidate dataset specifically includes: executing the target data service by a plurality of neural network computing devices, respectively, based on their own loaded copies of the graph structure and the same one candidate dataset.

In the above-described embodiments, the implementation of updating the candidate dataset and the neural network graph structure respectively is introduced. After the process of the target data service is started, the candidate dataset and the neural network graph structure may be loaded into the process, and the operations described in S201-S202 are executed. After (part of or all the candidate data in) the candidate dataset is updated independently, it's distributed to the process of the target data service independently. After the graph structure is updated, it is distributed to the process of the target data service separately.

Moreover, in other possible implementations, there may be a need to distribute the data and the graph structure as a whole. Therefore, it is not excluded the case that although the graph structure is decoupled from the candidate dataset, there are some scenarios where the graph structure and the data need to be distributed and used as a whole. Therefore, the data service method provided in the embodiment of the present disclosure may further include:
packaging the candidate dataset and the neural network graph structure into one data packet;
updating the whole data packet when at least one of the candidate dataset and the neural network graph structure needs to be updated; and
distributing (loading) the new data packet as a whole into the process of the target data service when the target data service is required.

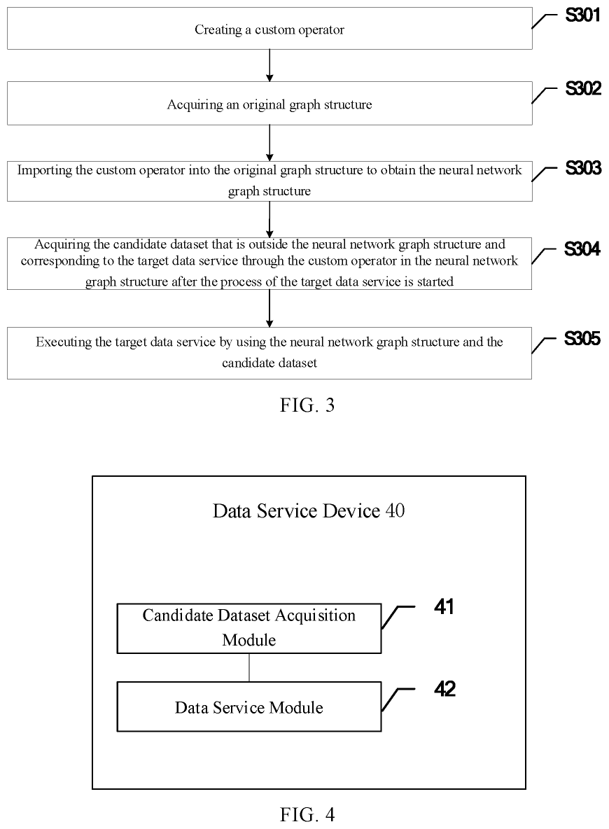

The previous embodiment focuses on the usage mode of the custom operator. In order to facilitate understanding, the process of creating a custom operator and the process of graph calculation will be described below in conjunction with embodiments and drawings. FIG. 3 is a flowchart of another data service method provided by an embodiment of the present disclosure. The data service method shown in FIG. 3 includes the following steps.

S301: creating a custom operator.

The custom operator used in the embodiments of the present disclosure is the most remarkable difference of the neural network graph structure from other existing neural network graph structures. In order to create a custom operator, it is necessary to firstly encapsulate an implementation method of accessing the candidate data by the custom operator. It may be implemented by defining an encapsulation class A and a management class B. Detailed introduction will be given as below.

Specifically, an encapsulation class A of a dataset (that is, a data structure where large-scale candidate data is resident, such as a matrix, which may also be understood as the previously-described candidate dataset) is defined in a common database under a framework such as TensorFlow, PyTorch, or the like, and such class is configured to describe a dataset with a specific access interface. The interfaces defined by the encapsulation class A includes the following:
1) an interface transferring full data in the form of matrix parameters or byte streams into a dataset object. This interface is configured to update the whole candidate dataset.
2) an interface transferring incremental data in the form of matrix parameters or byte streams into the dataset object, and the thread safety of incremental writing is guaranteed by means of internally locked queue or lock-free queue. This interface is configured to update part of candidate data in the candidate dataset.
3) an interface providing query for a content of a single or multiple pieces of data through data identification. This interface is configured for the custom operator inside the graph to access the data.
4) an interface defining serialization and deserialization of the internal data of the dataset. This interface is configured for the overall distribution and loading of the dataset.

In addition, features that the encapsulation class A further needs to support include that, a memory allocation method (e.g., whether to distribute a transparent large-page internal memory or a video memory) can be controlled by parameters.

A management class B of a singleton dataset is defined in the common database, and an operation of the dataset is packaged. The interfaces as defined include:
1) Managing the dataset.
2) an interface registering the dataset object to the management class through a primary key of the dataset.
3) an interface querying and obtain a smart pointer address of the dataset according to the primary key of the dataset.
4) an interface replacing the dataset object with the primary key of the dataset.
5) an interface deleting the primary key of the dataset from the dataset.

Hereinafter, the specific implementation of a singleton in the process will be described.

When a singleton is created, a name obtained by splicing according to a pid number of the process is automatically generated, a system shared memory block is registered with this name, and a memory address of the singleton is written into the shared memory block when the singleton object is initialized. What is different from the general singleton implementations is that, this implementation ensures that a code in .so dynamic link library can also access the same singleton. Therefore, both a C++ code implemented by C++ language and a python code in a python virtual machine can access the one and same singleton in one process.

Through the definition of the encapsulation class A and the management class B, a unified encapsulation for data access of the custom operator is realized. Hereinafter, the implementation of the custom operator will be introduced.

The custom operator with functions required in the technical solution of the embodiment of the present disclosure is defined under the framework of Tensorflow, PyTorch or the like. Specifically, it is necessary to define an input parameter of this operator inside the graph and an output data structure. As an example, the input parameter of the custom operator inside the graph may be a data name list of data participating in the graph calculation of the data service; the output data structure may be a tensor in the form of vector query result or a tensor in the form of vector dot-product result, etc. In addition, an attribute is added to the custom operator, that is, the name of the dataset corresponding to the custom operator.

The custom operator references header files of an encapsulation class A and a management class B of a common database, and in an initialization function of the operator, an object b of the management class B of the singleton is accessed, an object a of the dataset A is obtained by querying through the name of the dataset corresponding to the operator itself, and a pointer address of the object a is saved. In an execution function of the custom operator, the address of the object a is invoked to access its data query method, and the output data structure is returned after a simple calculation. The custom operator is compiled to obtain a dynamic link library, so that the custom operator can be registered to a framework such as Tensorflow, PyTorch, or the like in C++/Python codes and can be imported into the framework.

S302: acquiring an original graph structure.

The original graph structure is specifically a neural network graph structure before the custom operator is imported. In order to distinguish it from the neural network graph structure after the custom operator is imported, it is named the original graph structure here. The original graph structure is obtained by training in advance based on the detailed content of the target data service. Since the target data service may include many implementations, the training mode and training data of the original graph structure are not limited here.

S303: importing the custom operator into the original graph structure to obtain the neural network graph structure.

Taken Tensorflow framework as an example, the custom operator is merged into the original graph structure through an interface of Tensorflow, such as python API, before online reasoning calculation, so that the custom operator can participate in the calculation process of the graph structure. Hereinafter, the modification to the graph structure is introduced, together with the collecting and processing processes of the candidate data. In the embodiments of the present disclosure, the deep learning graph computing architecture is divided into an offline architecture and an online architecture, wherein the offline architecture is well prepared before online computing, while the online architecture is an architecture used for online computing according to the requirements of the target data service. In this step, it mainly involves the formation of the offline computing architecture; that is, obtaining the network graph structure after the custom operator is imported.

Firstly, a batch processing of the candidate data under offline condition is introduced as below.
1. Initializing the management class B of the dataset.
2. Scanning and obtaining all candidate data from a candidate data center, packaging the candidate data into the encapsulation class A of the dataset, and assigning a globally unique dataset name thereto.
3. Invoking the data serialization interface of the encapsulation class A of the dataset and writing the data into a file.
4. Activating a python virtual machine in the process and initializing a
dependency related to a running environment of deep graph.
5. Pulling the original graph structure from a training center and loading the original graph structure into the running environment.
6. Loading the custom operator into the running environment by means of dynamic link library, and initializing an attribute such as the name of the dataset.
7. Modifying the graph structure through the API of the deep learning framework, and adding the custom operator to the graph structure.
8. Reserializing the modified graph structure (i.e., the neural network graph structure) to a file.
9. Packaging the files obtained in step 3 and step 8 as described above, with additional matching information.

Hereinafter, the real-time processing and transmission of data under an offline condition (involving the update of candidate data under the offline condition) will be introduced.
1. Creating a distributed data update queue corresponding to the dataset based on a batch processing.
2. Writing a name of the data update queue into the additional matching information of step 9 based on a batch processing.
3. Monitoring a change of the candidate data center to obtain updated candidate data.
4. Writing the updated candidate data into the distributed data update queue.

S304: acquiring the candidate dataset that is outside the neural network graph structure and corresponding to the target data service through the custom operator in the neural network graph structure after the process of the target data service is started.

The implementation of the online computing architecture includes: a loading process of the neural network graph structure and the data, a real-time updating process of the data, and a batch replacement process of the data.
1. Initializing the running environment, and initializing the management class B of the dataset.
2. Loading the custom operator into the running environment by means of dynamic link library.
3. Downloading and reading a file package of batch data, in which the candidate data is loaded through the encapsulation class A of the dataset, and the neural network graph structure containing the custom operator is loaded through an interface of the deep learning framework when running.
4. an external service capability in the form of a graph computing interface can be provided upon the loading of the data and the graph structure being completed.

Specifically, after the loading of the graph structure is completed and when the process of the target data service is started, the dataset (i.e., the candidate dataset) can be acquired by the custom operator through the encapsulation class A and the management class B of the dataset wherein the custom operator is located.

In the scenario where the candidate data is updated in real time, the following step 5 is also involved.
5. Subscribing a data update stream according to the name of the data update queue written in the matching information, and writing the real-time updated data into the encapsulation class A of the dataset when the candidate data needs to be updated in real time, thus realizing the real-time update of the data.

In the scenario where the data needs to be replaced in batches, the steps 1-5 under the step S304 are repeatedly executed after the next batch of data arrives, so that the candidate data can be replaced in batches, for example, the whole dataset can be replaced.

S305: executing the target data service by using the neural network graph structure and the candidate dataset.

In the above-described embodiment, by creating the custom operator, the candidate data outside the graph structure can be invoked inside the graph structure, and the candidate data can be updated and replaced in real time and in batches, including incremental replacement or full replacement. Therefore, the actual usage requirements are satisfied, and the result of target data service is assisted to be more accurate, stable, and better match the demands.

Based on the data service method provided by the above-described embodiments, the embodiments of the present disclosure also provide a data service device correspondingly. The device will be described in details in conjunction with embodiments as below.

FIG. 4 is a schematic structural diagram of a data service device provided by an embodiment of the present disclosure. The data service device 40 shown in FIG. 4 includes:
a candidate dataset acquisition module 41, configured to acquire a candidate dataset that is outside a neural network graph structure and corresponding to a target data service through a custom operator in the neural network graph structure after a process of the target data service is started; and
a data service module 42, configured to execute the target data service by using the neural network graph structure and the candidate dataset.

In the embodiment of the present disclosure, a hybrid graph computing framework that combines the usage mode inside the graph with the usage mode outside the graph is realized with the aid of a custom operator. Among them, the custom operator is located inside the graph (that is, within the graph structure), and the candidate data is located outside the graph (that is, outside the graph structure). The custom operator inside the graph can access and acquire the candidate data outside the graph, so that the candidate data can participate in the target data service. In this solution, the candidate data is not solidified in the graph structure, and hence can be decoupled from the graph structure. Therefore, the degree of freedom of updating and storing the candidate data is improved. In addition, the candidate data is accessed and read by the custom operator, and is not used as an input parameter of the whole graph structure; therefore, the influence of the candidate data on the parameters in the graph structure is avoided. In this way, unnecessary computational resource overhead is avoided, and the difficulty in implementing parameter transfer and parameter maintenance in the graph structure is reduced.

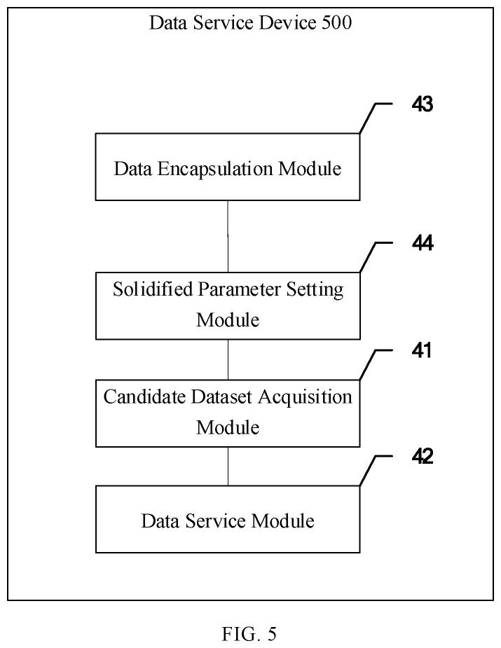

Optionally, FIG. 5 illustrates the structure of another data service device 500. As shown in FIG. 5, the data service device 500 includes a candidate dataset acquisition module 41 and a data service module 42, and further includes:
a data encapsulation module 43, configured to encapsulate the candidate data into a data structure outside the neural network graph structure to form the candidate dataset; and
a solidified parameter setting module 44, configured to set a name of the candidate dataset as a solidified parameter of the custom operator.

The candidate dataset acquisition module 41 includes:
a carrier acquisition unit, configured to obtain a preset information carrier through the custom operator according to the solidified parameter;
an address acquisition unit, configured to obtain a pointer address of the candidate dataset according to the preset information carrier; and
a data acquisition unit, configured to access the candidate dataset according to the pointer address.

Optionally, the data service device includes a candidate dataset acquisition module 41 and a data service module 42, and further includes:
a data encapsulation module 43, configured to encapsulate the candidate data into a data structure outside the neural network graph structure to form the candidate dataset;
a dataset encapsulation module, configured to encapsulate the candidate dataset to obtain an encapsulation class of the candidate dataset; and
a candidate dataset acquisition module 41, configured for the custom operator acquiring the candidate dataset through invoking an interface function of the encapsulation class, or acquiring a calculation result obtained by performing a preset calculation based on the candidate dataset.

Optionally, the data service device further includes:
a data identification acquisition module, configured to acquire an identification of the target candidate data, wherein the candidate dataset contains the target candidate data.

The data service module 42 includes:
a data extraction unit, configured to extract the target candidate data from the candidate dataset according to the identification of the target candidate data, or perform a preset calculation on the target candidate data from the encapsulation class of the candidate dataset according to the identification of the target candidate data and obtain a calculation result; and
an execution unit, configured to execute the target data service by using the neural network graph structure and the target candidate data, or execute the target data service by using the neural network graph structure and the calculation result.

Optionally, the neural network graph structure has a plurality of copies, and the plurality of copies are loaded into a plurality of neural network computing devices in one-to-one correspondence; the candidate data is stored outside the plurality of neural network computing devices. The plurality of neural network computing devices are a plurality of graphics cards.

The data service module 42 is specifically configured to execute the target data service by the plurality of neural network computing devices, respectively, based on their own loaded copies and the one and same candidate dataset.

Optionally, the data service device mentioned above further includes:
a first update module, configured to independently update the candidate dataset and/or independently update the neural network graph structure.

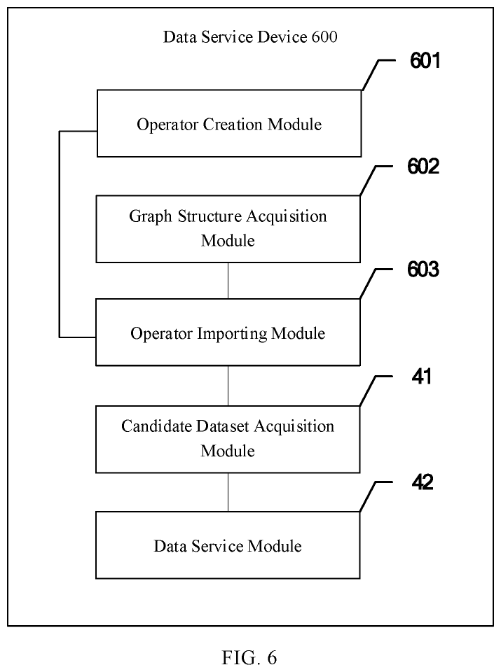

FIG. 6 is a schematic structural diagram of another data service device provided by yet another embodiment of the present disclosure. As shown in FIG. 6, the data service device 600 includes a candidate dataset acquisition module 41 and a data service module 42, and further includes:
an operator creation module 601, configured to create a custom operator;
a graph structure acquisition module 602, configured to acquire an original graph structure; and
an operator importing module 603, configured to import the custom operator into the original graph structure to obtain the neural network graph structure.

By creating a custom operator, the candidate dataset outside the graph structure can be invoked inside the graph structure, and the candidate data can be updated and replaced in real time and in batches. Therefore, the actual usage requirements are satisfied, and the effect of aiding in the target data service is more accurate, stable, and better match the demands.

The data service device provide by the embodiment of the present disclosure can execute the data service method provided by any embodiment of the present disclosure, and has corresponding functional units for executing the data service method and achieves the same beneficial effects.

It is worth noting that in the above embodiment of the data service device, the units as included are divided according to functional logics only, but it is not limited to the above division if the corresponding functions can be realized. In addition, the specific names of these functional units are also only for the convenience of distinguishing from each other, and are not used to limit the protection scope of the embodiment of the present disclosure.

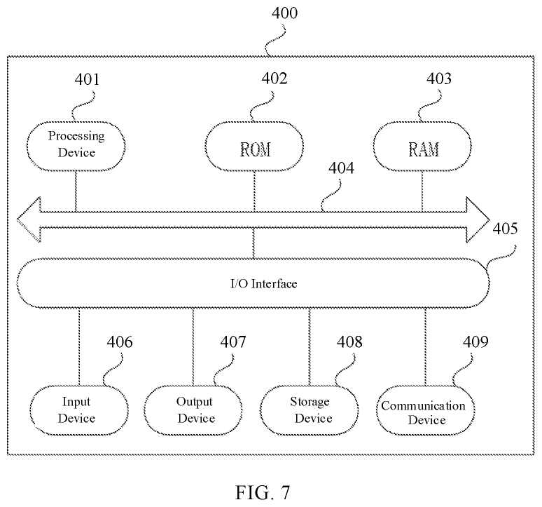

Referring to FIG. 7, FIG. 7 illustrates a schematic structural diagram of an electronic apparatus (e.g., a terminal apparatus has software programs running thereon) 400 suitable for implementing the embodiments of the present disclosure. The electronic apparatus in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The electronic apparatus illustrated in FIG. 7 is merely an example, and should not pose any limitation to the functions and the range of use of the embodiments of the present disclosure.

As illustrated in FIG. 7, the electronic apparatus 400 may include a processing device 401 (e.g., processor such as a central processing unit, a graphics processing unit, etc.), which can perform various suitable actions and processing according to a program stored in a read-only memory (ROM) 402 or a program loaded from a storage device 408 into a random-access memory (RAM) 403. The RAM 403 further stores various programs and data required for operations of the electronic apparatus 400. The processing device 401, the ROM 402, and the RAM 403 are interconnected by means of a bus 404. An input/output (I/O) interface 405 is also connected to the bus 404.

Usually, the following devices may be connected to the I/O interface 405: an input device 406 including, for example, a touch screen, a touch pad, a keyboard, a mouse, a camera, a microphone, an accelerometer, a gyroscope, or the like; an output device 407 including, for example, a liquid crystal display (LCD), a loudspeaker, a vibrator, or the like; a storage device 408 including, for example, a magnetic tape, a hard disk, or the like; and a communication device 409. The communication device 409 may allow the electronic apparatus 400 to be in wireless or wired communication with other apparatuses to exchange data. While FIG. 7 illustrates the electronic apparatus 400 having various devices, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in FIG. 1. In such embodiments, the computer program may be downloaded online through the communication device 409 and installed, or may be installed from the storage device 408, or may be installed from the ROM 402. When the computer program is executed by the processing device 401, the above-mentioned functions defined in the methods of some embodiments of the present disclosure are performed.

The electronic apparatus provided by the embodiment of the present disclosure belongs to the same inventive concept as the data service method provided by the above embodiments, and the technical details not particularly described in this embodiment of the present disclosure can be found in the above embodiments, and this embodiment of the present disclosure achieves the same beneficial effects as the above embodiments.

The embodiment of the present disclosure provides a computer storage medium having a computer program stored therein, wherein the computer program is configured to realize the data service method provided by the above embodiment when executed by a processer.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination thereof. In the embodiment of the present disclosure, the computer-readable storage medium may be any tangible medium containing or storing a program that can be used by or in combination with an instruction execution system, apparatus or device. In the embodiment of the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) or the like, or any appropriate combination thereof.

In some implementation modes, the client and the server may communicate utilizing any network protocol currently known or to be researched and developed in the future such as hypertext transfer protocol (HTTP), and may interconnect with digital data communication in any form or medium (e.g., a communication network). Examples of the communication network include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic apparatus, or may also exist alone without being assembled into the electronic apparatus.

The above-described computer-readable medium carries one or more programs that, when executed by the electronic apparatus, cause the electronic apparatus to:
acquire a candidate dataset that is outside a neural network graph structure and corresponding to a target data service through a custom operator in the neural network graph structure after a process of the target data service is started; and execute the target data service by using the neural network graph structure and the candidate dataset.

The computer program codes for performing the operations of the embodiment of the present disclosure may be written in one or more programming languages or a combination thereof by the computer-readable storage medium. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, device or apparatus. The machine-readable medium may be a machine-readable signal medium or a machine-readable storage medium. The machine-readable medium includes, but is not limited to, an electrical, magnetic, optical, electromagnetic, infrared, or semiconductor system, device or apparatus, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The above description is merely the preferred embodiments of the present disclosure and the explanation of the applied technical principles. It should be understood by those skilled in the art that the disclosure scope involved in the embodiments of the present disclosure is not limited to the technical solution(s) formed by the specific combination(s) of the above technical features, but also covers other technical solution(s) formed by any combination of the above technical features or their equivalent features without departing from the above disclosure concept, such as the technical solution(s) formed by replacing the above features with (but not limited to) technical features having similar functions disclosed in the embodiments of the present disclosure.

Furthermore, although the operations are depicted in a particular order, this should not be understood as requiring that these operations be performed in the particular order as illustrated or in a sequential order. Under certain circumstances, multitasking and parallel processing may be beneficial. Similarly, although several specific implementation details are contained in the above discussion, these should not be interpreted as limiting the scope of the embodiments of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological acts, it should be understood that the subject matter defined in the appended claims is not necessarily limited to the specific features or acts described above. On the contrary, the specific features and actions described above are only exemplary forms of implementing the claims.

1. A data service method, comprising:
acquiring a candidate dataset that is outside a neural network graph structure and corresponding to a target data service through a custom operator in the neural network graph structure after a process of the target data service being started; and
executing the target data service by using the neural network graph structure and the candidate dataset.

2. The data service method according to claim 1, further comprising:
encapsulating candidate data into a data structure outside the neural network graph structure to form the candidate dataset; and
setting a name of the candidate dataset as a solidified parameter of the custom operator,
wherein the acquiring the candidate dataset that is outside the neural network graph structure and corresponding to the target data service through the custom operator in the neural network graph structure comprises:
obtaining a preset information carrier according to the solidified parameter through the custom operator;
obtaining a pointer address of the candidate dataset according to the preset information carrier; and
accessing the candidate dataset according to the pointer address.

3. The data service method according to claim 1, further comprising:
encapsulating candidate data into a data structure outside the neural network graph structure to form the candidate dataset; and
encapsulating the candidate dataset to obtain an encapsulation class of the candidate dataset,
wherein the acquiring the candidate dataset that is outside the neural network graph structure and corresponding to the target data service through the custom operator in the neural network graph structure comprises:
acquiring the candidate dataset or acquiring a calculation result obtained through performing a preset calculation based on the candidate dataset, by the custom operator through invoking an interface function of the encapsulation class.

4. The data service method according to claim 1, further comprising:
acquiring an identification of target candidate data, wherein the candidate dataset contains the target candidate data,
the executing the target data service by using the neural network graph structure and the candidate dataset comprises:
extracting the target candidate data from the candidate dataset according to the identification of the target candidate data, and executing the target data service by using the neural network graph structure and the target candidate data; or,
performing a preset calculation on the target candidate data from an encapsulation class of the candidate dataset according to the identification of the target candidate data and obtaining a calculation result, and executing the target data service by using the neural network graph structure and the calculation result.

5. The data service method according to claim 1, wherein the neural network graph structure has a plurality of copies, and the plurality of copies are loaded into a plurality of neural network computing devices in one-to-one correspondence; the candidate dataset is stored outside the plurality of neural network computing devices,
the executing the target data service by using the neural network graph structure and the candidate dataset comprises:
executing the target data service by the plurality of neural network computing devices based on the plurality of copies loaded therein and the candidate dataset that is a same one, respectively.

6. The data service method according to claim 1, further comprising:
updating the candidate dataset independently, and/or,
updating the neural network graph structure independently.

7. The data service method according to claim 1, further comprising:
packaging the candidate dataset and the neural network graph structure into one data packet; and
updating the one data packet upon at least one of the candidate dataset and the neural network graph structure being required for an update.

8. The data service method according to claim 2, wherein the preset information carrier comprises a static variable, a shared variable in a shared memory, or a file.

9. The data service method according to claim 1, further comprising:
creating the custom operator;
acquiring an original graph structure; and
importing the custom operator into the original graph structure and obtaining the neural network graph structure.

10. The data service method according to claim 5, wherein the neural network computing device is a graphics card.

11-12. (canceled)

13. An electronic apparatus for data service, comprising:
one or more processors; and
a memory configured for storing one or more programs,
wherein the one or more programs, upon being executed by the one or more processors, are configured to cause the one or more processors to realize a data service method comprising: acquiring a candidate dataset that is outside a neural network graph structure and corresponding to a target data service through a custom operator in the neural network graph structure after a process of the target data service being started; and executing the target data service by using the neural network graph structure and the candidate dataset.

14. A computer-readable storage medium having a computer program stored thereon, wherein the computer program is configured to realize a data service method upon being executed by a processor,
wherein the data service method comprises: acquiring a candidate dataset that is outside a neural network graph structure and corresponding to a target data service through a custom operator in the neural network graph structure after a process of the target data service being started; and executing the target data service by using the neural network graph structure and the candidate dataset.

15. The electronic apparatus for data service according to claim 13, wherein the data service method further comprises:
encapsulating candidate data into a data structure outside the neural network graph structure to form the candidate dataset; and
setting a name of the candidate dataset as a solidified parameter of the custom operator,
wherein the acquiring the candidate dataset that is outside the neural network graph structure and corresponding to the target data service through the custom operator in the neural network graph structure comprises:
obtaining a preset information carrier according to the solidified parameter through the custom operator;
obtaining a pointer address of the candidate dataset according to the preset information carrier; and
accessing the candidate dataset according to the pointer address.

16. The electronic apparatus for data service according to claim 13, wherein the data service method further comprises:
encapsulating candidate data into a data structure outside the neural network graph structure to form the candidate dataset; and
encapsulating the candidate dataset to obtain an encapsulation class of the candidate dataset,
wherein the acquiring the candidate dataset that is outside the neural network graph structure and corresponding to the target data service through the custom operator in the neural network graph structure comprises:
acquiring the candidate dataset or acquiring a calculation result obtained through performing a preset calculation based on the candidate dataset, by the custom operator through invoking an interface function of the encapsulation class.

17. The electronic apparatus for data service according to claim 13, wherein the data service method further comprises:
acquiring an identification of target candidate data, wherein the candidate dataset contains the target candidate data,
the executing the target data service by using the neural network graph structure and the candidate dataset comprises:
extracting the target candidate data from the candidate dataset according to the identification of the target candidate data, and executing the target data service by using the neural network graph structure and the target candidate data; or,
performing a preset calculation on the target candidate data from an encapsulation class of the candidate dataset according to the identification of the target candidate data and obtaining a calculation result, and executing the target data service by using the neural network graph structure and the calculation result.

18. The electronic apparatus for data service according to claim 13, wherein the neural network graph structure has a plurality of copies, and the plurality of copies are loaded into a plurality of neural network computing devices in one-to-one correspondence; the candidate dataset is stored outside the plurality of neural network computing devices,
the executing the target data service by using the neural network graph structure and the candidate dataset comprises:
executing the target data service by the plurality of neural network computing devices based on the plurality of copies loaded therein and the candidate dataset that is a same one, respectively.

19. The electronic apparatus for data service according to claim 13, wherein the data service method further comprises:
updating the candidate dataset independently, and/or,
updating the neural network graph structure independently.

20. The electronic apparatus for data service according to claim 13, wherein the data service method further comprises:
packaging the candidate dataset and the neural network graph structure into one data packet; and
updating the one data packet upon at least one of the candidate dataset and the neural network graph structure being required for an update.

21. The electronic apparatus for data service according to claim 15, wherein the preset information carrier comprises a static variable, a shared variable in a shared memory, or a file.

22. The electronic apparatus for data service according to claim 13, wherein the data service method further comprises:
creating the custom operator;
acquiring an original graph structure; and
importing the custom operator into the original graph structure and obtaining the neural network graph structure.
